(19) United States
(12) Patent Application Publication
(10) Pub. No.: US 2014/0166216 A1
(43) Pub. Date: Jun. 19, 2014

(54) COMBINATION OF ROMAN SHADE AND HONEYCOMB SHADE

(71) Applicant: CHING FENG HOME FASHIONS CO., LTD., Fuxing Shiang (TW)

(72) Inventors: SHENG-YING HSU, Fuxing Shiang (TW); WU-CHUNG NIEN, Fuxing Shiang (TW)

(73) Assignee: CHING FENG HOME FASHIONS CO., LTD., Fuxing Shiang (TW)

(21) Appl. No.: 14/071,649

(22) Filed: Nov. 5, 2013

(30) Foreign Application Priority Data
Dec. 18, 2012 (TW) 101224484

(51) Int. Cl. E06B 9/262

(52) U.S. Cl. CPC E06B 9/262
USPC 160/84.03

(57) ABSTRACT

A window shade includes a head box with a top shade control unit and a bottom shade control unit received therein. The top shade control unit has a first cord connected thereto and the bottom shade control unit has a second cord connected thereto. A shade unit has a top shade which is connected between the head box and an intermediate bar, and a bottom shade which is connected between the intermediate bar and a bottom bar. The first cord extends through the top shade and is connected to the intermediate bar. The second cord extends through the bottom shade and is connected to the bottom bar. The top and bottom shades can be individually controlled.

### FIELD OF THE INVENTION

The present invention relates to a window shade, and more particularly, to a combination of Roman shade and honeycomb shade.

### BACKGROUND OF THE INVENTION

The conventional Roman shade occupies less space and can be matched with the window. There are multiple transverse bars connected to the Roman shade and the transverse bars increase the weight of the Roman shade so that the Roman shade is not blown away from the window. The Roman shade is easily cleaned by removing the transverse bars. The conventional honeycomb shade comprises multiple continuous honeycomb sections which can keep the hot temperature out from the interior and multiple colors are available. The honeycomb shade also allows the light to be introduced into the interior of the room while the privacy is kept. The two different types of the window shades are welcomed by the users, however, they are individually purchased and installed.

The present invention intends to provide a combination of Roman shade and honeycomb shade.

### SUMMARY OF THE INVENTION

The present invention relates to a window shade and comprises a head box with a top shade control unit and a bottom shade control unit received therein. The top shade control unit has a first cord connected thereto and the bottom shade control unit has a second cord connected thereto. A shade unit has a top shade, an intermediate bar, a bottom shade and a bottom bar. The top shade is connected between the head box and the intermediate bar, and the bottom shade which is connected between the intermediate bar and the bottom bar. The first cord extends through the top shade and is connected to the intermediate bar. The second cord extends through the bottom shade and is connected to the bottom bar.

The primary object of the present invention is to provide a window shade which comprises a Roman shade and a honeycomb shade. The Roman shade and the honeycomb shade can be individually controlled.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the window shade of the present invention;

FIG. 2 shows that the top shade is partially collapsed and the bottom shade is fully collapsed;

FIG. 3 shows that the top shade is partially collapsed and the bottom shade is partially collapsed;

FIG. 4 shows that the top shade is fully collapsed and the bottom shade is fully expanded;

FIG. 5 shows a cover fabric is to be connected to the top shade;

FIG. 6 shows two cover fabrics are connected to the top shade;

FIG. 7 is a side view to show the top shade;

FIG. 8 is a side view to show the bottom shade;

FIG. 9 shows the head box of the window shade of the present invention, and

FIG. 10 shows another embodiment of the head box of the window shade of the present invention.

### DETAILED DESCRIPTION OF THE PREFERRED EMBODIMENT

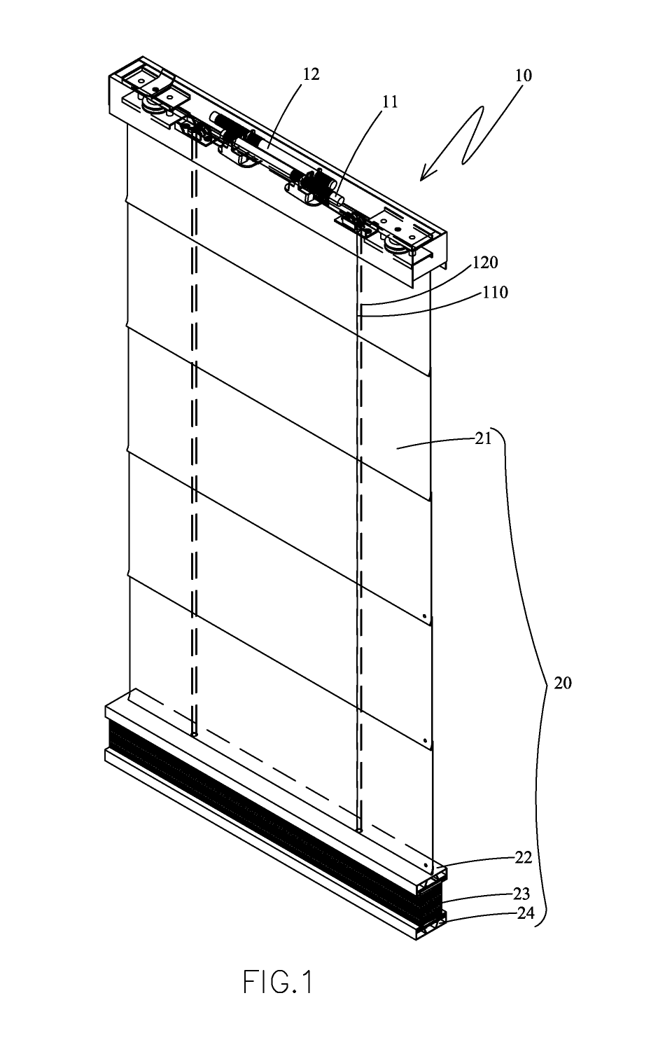

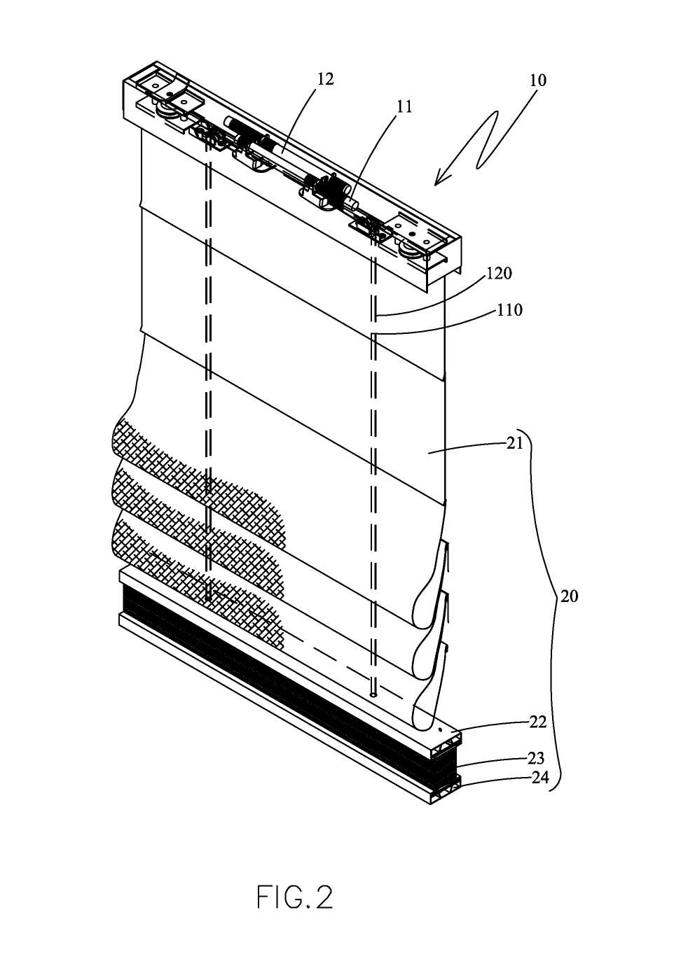

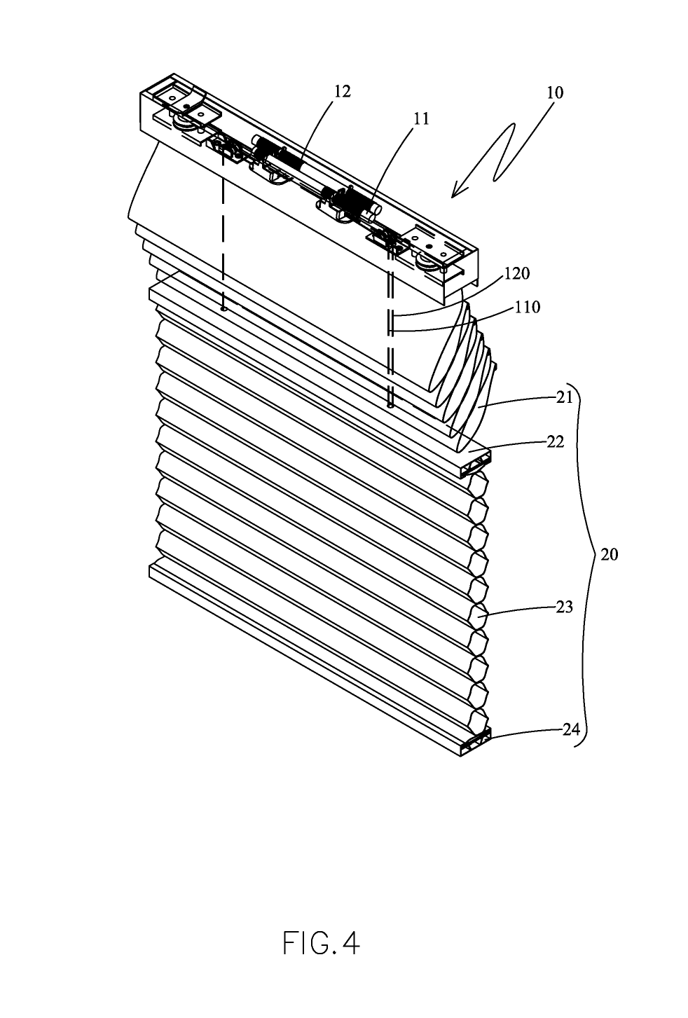

Referring to FIGS. 1 to 4, the window shade of the present invention comprises a head box 10 which has a top shade control unit 11 and a bottom shade control unit 12 received therein. The top shade control unit 11 has a first cord 110 connected thereto and the bottom shade control unit 12 has a second cord 120 connected thereto.

A shade unit 20 comprises a top shade 21, an intermediate bar 22, a bottom shade 23 and a bottom bar 24. The lower end of the top shade 21 is connected to the top of the intermediate bar 22. The bottom shade 23 is connected between the underside of the intermediate bar 22 and the bottom bar 24. The first cord 110 extends through the top shade 21 and is connected to the intermediate bar 22. The second cord 120 extends through the bottom shade 23 and is connected to the bottom bar 24.

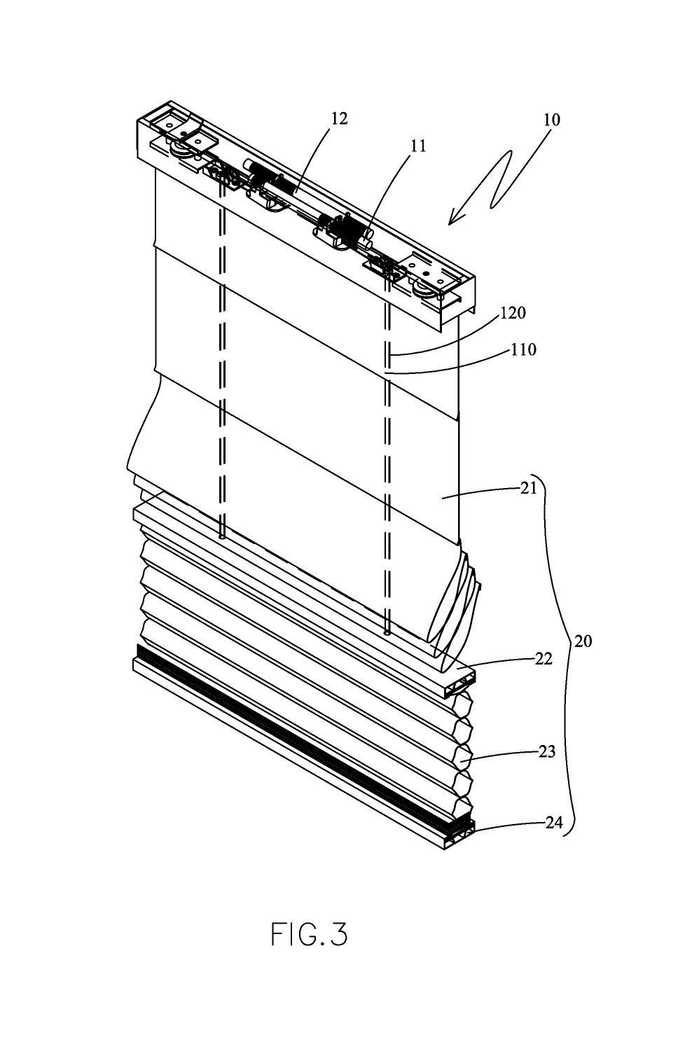

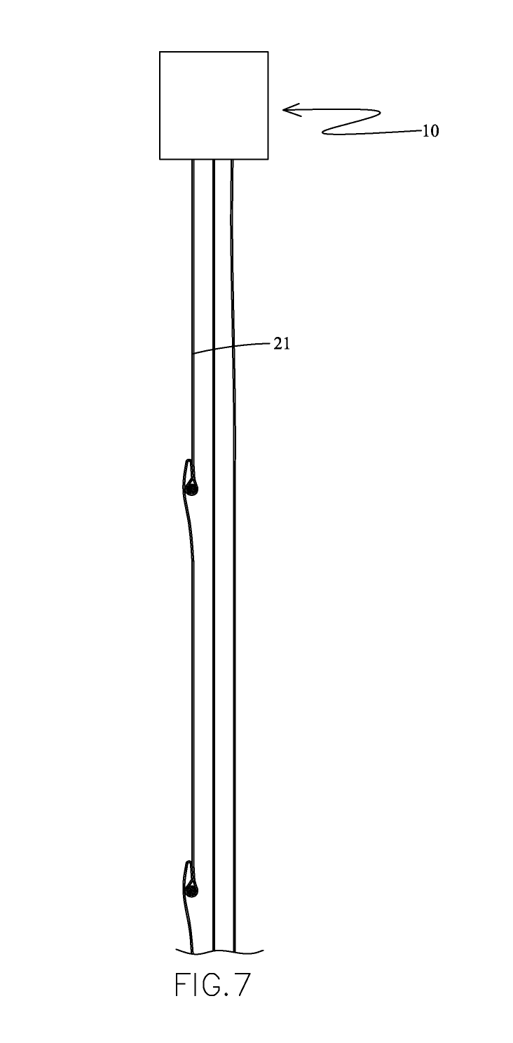

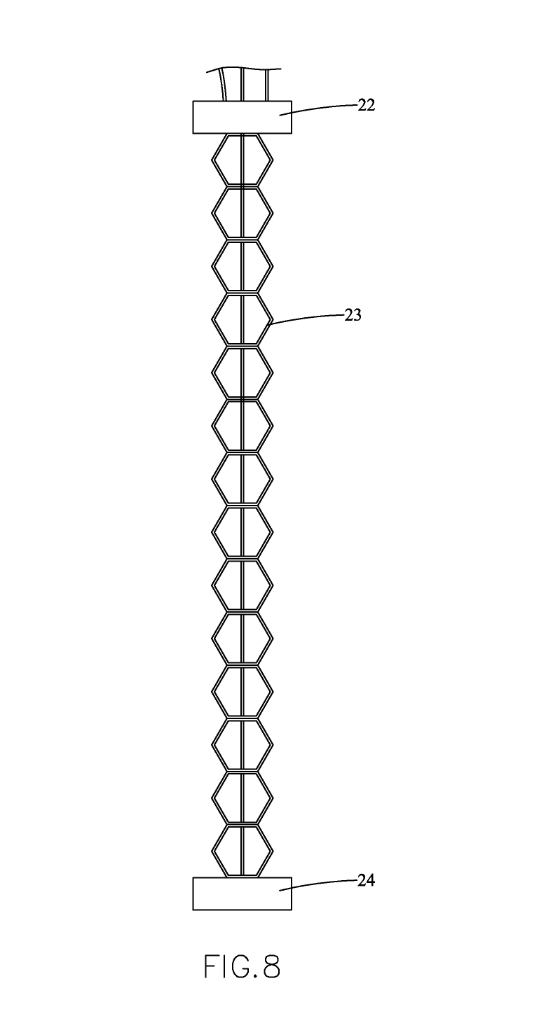

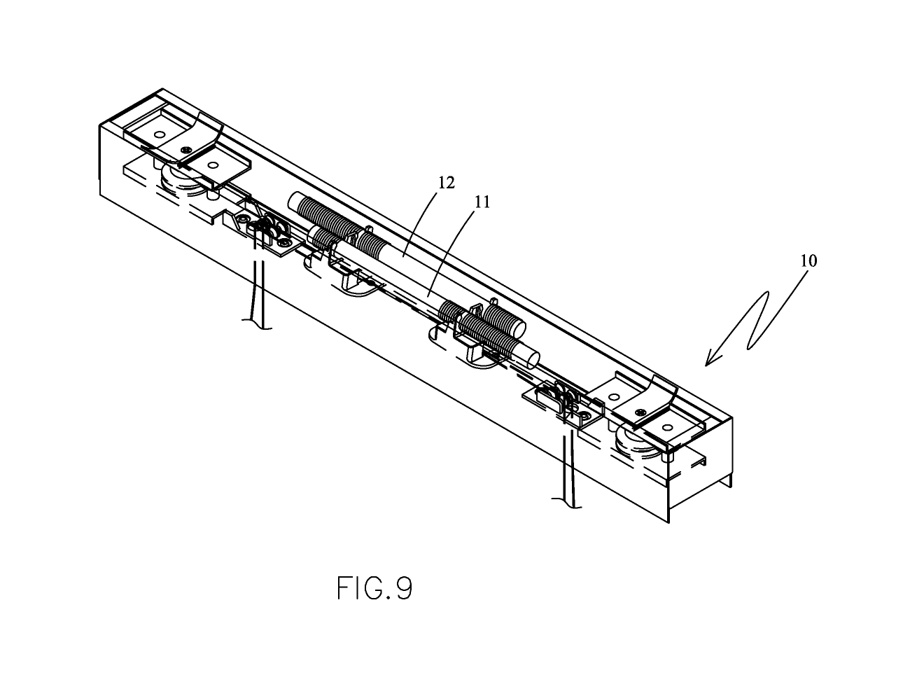

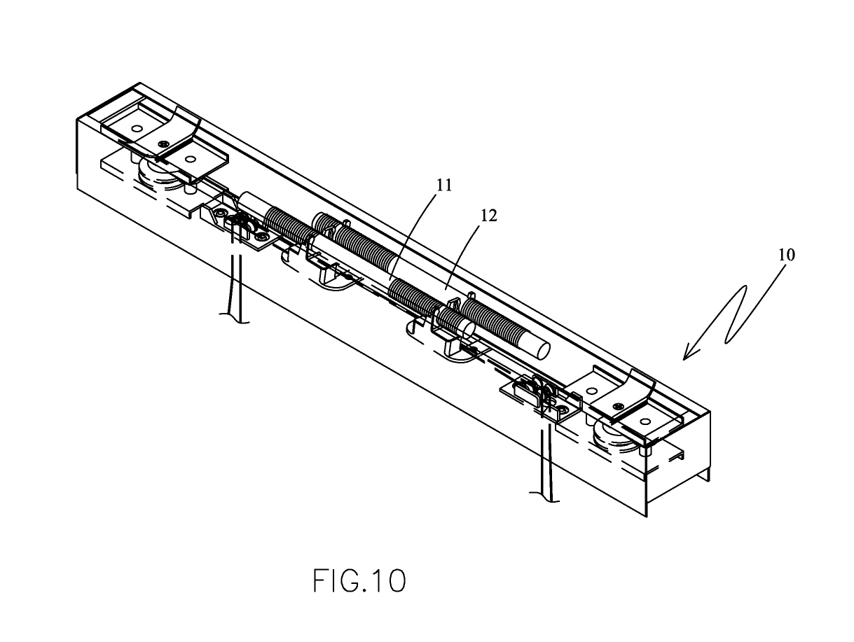

Referring to FIGS. 3 to 10, the top shade 21 is a Roman shade and the bottom shade 23 is a honeycomb shade. By operating the top shade control unit 11, the top shade 21 (the Roman shade) can be controlled, and by operating the bottom shade control unit 12, the bottom shade 23 (the honeycomb shade) can be operated. In other words, the top and bottom shades 21, 23 can be individually controlled. Alternatively, the top shade 21 can be a honeycomb shade and the bottom shade 23 can be a Roman shade.

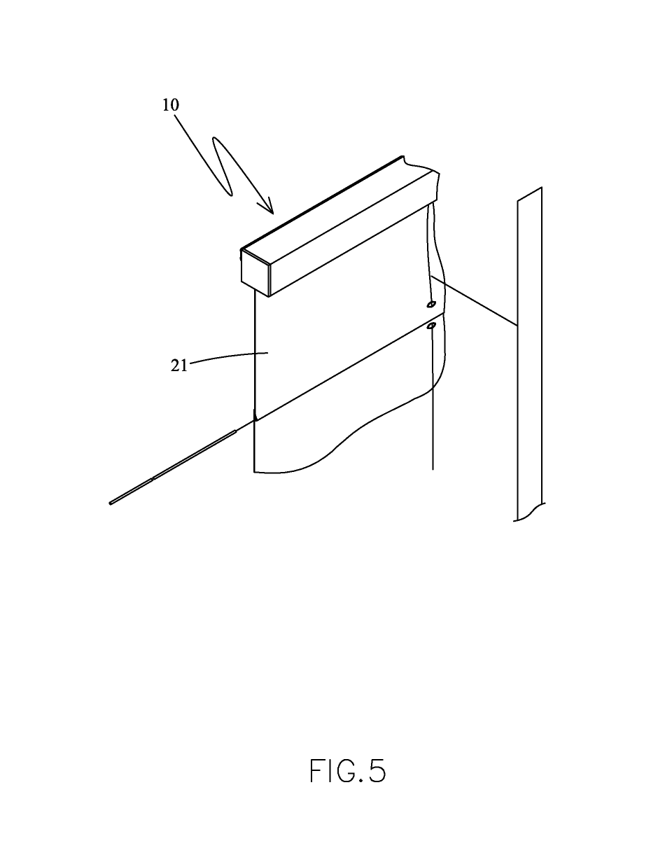

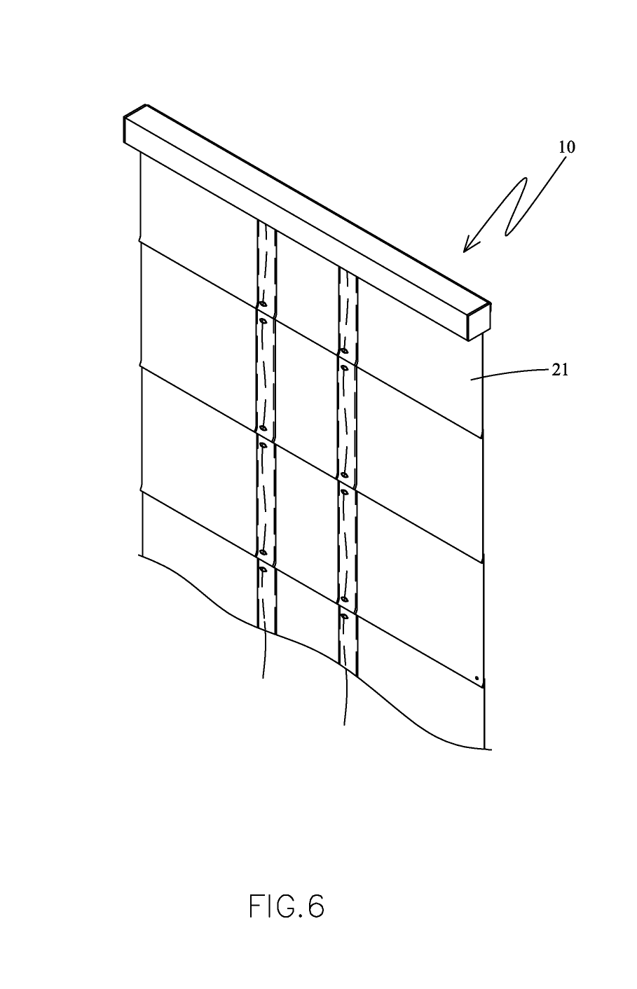

Referring to FIGS. 5 and 6, two cover fabrics are connected to the top shade 21 to cover up the first and second cords 110, 120. The first and second cords 110, 120 are hidden by the two cover fabrics so that the first and second cords 110, 120 are not pulled away from the shade unit 20.

The window shade of the present invention combines two different types of shades so that the users can arrange the different shades according practical needs. Each of the top and bottom shades 21, 23 can be individually expanded or collapsed. The top and bottom shades 21, 23 can also be partially expanded or collapsed.

While we have shown and described the embodiment in accordance with the present invention, it should be clear to those skilled in the art that further embodiments may be made without departing from the scope of the present invention.

What is claimed is:

1. A window shade comprising:
a head box having a top shade control unit and a bottom shade control unit located therein, the top shade control unit having a first cord connected thereto and the bottom shade control unit having a second cord connected thereto, and a shade unit having a top shade, an intermediate bar, a bottom shade and a bottom bar, a lower end of the top shade connected to a top of the intermediate bar, the bottom shade connected between an underside of the intermediate bar and the bottom bar, the first cord extending through the top shade and connected to the intermediate bar, the second cord extending through the bottom shade and connected to the bottom bar.

2. The combination as claimed in claim 1, wherein the top shade is a Roman shade and the bottom shade is a honeycomb shade.

3. The combination as claimed in claim 1, wherein the top shade is a honeycomb shade and the bottom shade is a Roman shade.
